(19) United States
(12) Patent Application Publication
(10) Pub. No.: US 2024/0056783 A1
(43) Pub. Date: Feb. 15, 2024

(54) LOCALLY INTEGRATED SENSING AND COMMUNICATION

(71) Applicant: Apple Inc., Cupertino, CA (US)

(72) Inventors: Xiaoyu Qiao, Beijing (CN); Fangli Xu, Beijing (CN); Mona Agnel, Guildford (GB); Huarui Liang, Beijing (CN); Shu Guo, Beijing (CN); Haijing Hu, Los Gatos, CA (US); Dawei Zhang, Saratoga, CA (US); Lanpeng Chen, Beijing (CN)

(21) Appl. No.: 18/355,823

(22) Filed: Jul. 20, 2023

Related U.S. Application Data
(60) Provisional application No. 63/397,665, filed on Aug. 12, 2022.

(51) Int. Cl. H04W 4/38; H04W 12/06

(52) U.S. Cl. CPC H04W 4/38; H04W 12/06

(57) ABSTRACT

Techniques discussed herein can facilitate integrated sensing and communication (ISC), where a wireless network is used for both sensing and for wireless communications. One example aspect is sensing function entity configured to receive a sensing service request from an access and mobility function (AMF) entity, where the sensing service request is received by an access and mobility function/sensing function (AMF/SF) interface. The SF entity is further configured to transmit, by the AMF/SF interface, a sensing service response to the AMF entity and subsequently receive sensing data associated with the sensing service response, where the sensing data is received by a base station/sensing function (BS/SF) interface. The SF entity is further configured to process the sensing data, and transmit the sensing response after processing the sensing data.

### RELATED APPLICATIONS

This application claims the benefit of U.S. Provisional Application No. 63/397,665, filed on Aug. 12, 2022, the contents of which are hereby incorporated by reference in their entirety.

### FIELD

The present disclosure relates to wireless communication networks and mobile device capabilities.

### BACKGROUND

Mobile communication in the next generation wireless communication system, 5G, new radio (NR), sixth generation technology, and so on will provide ubiquitous connectivity and access to information, as well as the ability to share data, around the globe. Next generation wireless communication systems provide service-based framework that will target to meet versatile, and sometimes conflicting, performance criteria. Such technology may include solutions for enabling user equipment (UE) to communicate with one another directly.

### BRIEF DESCRIPTION OF THE DRAWINGS

FIG. 1 is an exemplary block diagram illustrating an example of user equipment(s) (UEs) communicatively coupled to a network in accordance with various aspects described herein.

FIG. 2 illustrates a non-roaming architecture with a sensing function (SF) that is locally integrated and associated interfaces between local network components and core network (CN) components.

FIG. 3 illustrates a diagram of a wireless network with integrated sensing signaling between various network functions and components, where the SF is locally integrated.

FIG. 4 illustrates a flow diagram of an example method by which a SF performs locally integrated sensing functions.

FIG. 5 illustrates a flow diagram of an example method by which an access and mobility function supports locally integrated sensing functions by sensing signaling and sensing messaging.

FIG. 6 illustrates a flow diagram of an example method by which a base station (BS) performs locally integrated sensing functions by perform sensing signaling, sensing messaging, and sensing procedures.

FIG. 7 illustrates a flow diagram of an example method by which a UE performs locally integrated sensing functions by perform sensing signaling, sensing messaging, and sensing procedures.

FIG. 8 illustrates an example of an infrastructure equipment, in accordance with various aspects disclosed.

FIG. 9 illustrates an example of a UE or BS platform, in accordance with various aspects disclosed.

### DETAILED DESCRIPTION

The present disclosure is described with reference to the attached figures. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

The present disclosure relates to integrated sensing and communication (ISC), where sensing capabilities are locally integrated in a wireless network, where the same wireless network is used for both sensing and for wireless communications.

Wireless networks (e.g., mobile communication networks, NR, next generation wireless, etc. . . . ) are primarily dedicated to wireless signaling of communication data. Sensor technology, and associated sensing, is a broad and growing field with a multitude of applications, where sensor technology predominantly lacks integrated wireless communication capabilities. Examples of sensing include environmental real-time monitoring for traffic, autonomous vehicle sensing, weather and pollution monitoring, medical device sensing, and the like. As such, present sensing solutions that utilize wireless communications rely on bridged technology solutions that interface between sensor technology and wireless networks where a device associated with the sensor is responsible for processing sensing data, and the wireless network is dedicated to communications. Existing wireless network standards fail to provide support for ISC where sensing capabilities are integrated with the wireless network.

Solutions provided herein include locally integrated sensing and communication where sensing capabilities are provided by the same wireless network used for wireless communications. The term “locally integrated” refers to sensing solutions where sensing data is received and processed locally, for example, by terminals, base stations (BSs), and edge computing, rather than solely relying on sensing data processing at the core network (CN) or by the sensing device. The burden of processing centrally at the CN can cause increased network overhead and delayed signaling, thus local integration leads to higher fidelity quality of service (QoS) amongst the wireless network when implementing ISC. Local ISC can enable sensing solutions where the burden of processing sensor data can be shifted from the sensor technology to the computing resources of the wireless network enabling a broad range of integrated sensing options. Solutions provided herein relate to several market segments including transportation, enterprise systems, smart homes/cities, factories, farms, consumer systems, virtual reality, and medicine. Furthermore, local ISC can enable sensing assisted communication capabilities where sensing is associated with communication channels to assist in radio frequency characterization, radio resource management, interference mitigation, beam management, and the like.

Various aspects of the present disclosure are directed towards a new network function (NF) for sensing, a sensing function (SF), that performs local processing of sensing data for ISC. In some aspects, the SF resides in a BS of a local network. The SF retrieves sensing data, processes sensing data, and transmits data processing results to other network elements by a sensing response. Mechanisms by which the local network, such as a user equipment (UE) and BS can communicate with the SF are presented herein. Mechanisms by which the CN communicates with the SF are presented herein. New interfaces are presented that enable local integration of the SF including a first sensing function interface (NS1) between the BS and the SF as well as a second sensing function interface (NS2) between the SF and an access and mobility function (AMF) of the CN. In some aspects, NS1 is referred to as a base station/sensing function interface, or BS/SF interface. In some aspects, the NS2 is referred to as an access and mobility function/sensing function interface, or AMF/SF interface. Mechanisms for integrating local sensing with network elements, procedures for initiating local sensing, and procedures for signaling between network elements during local sensing procedures are presented herein.

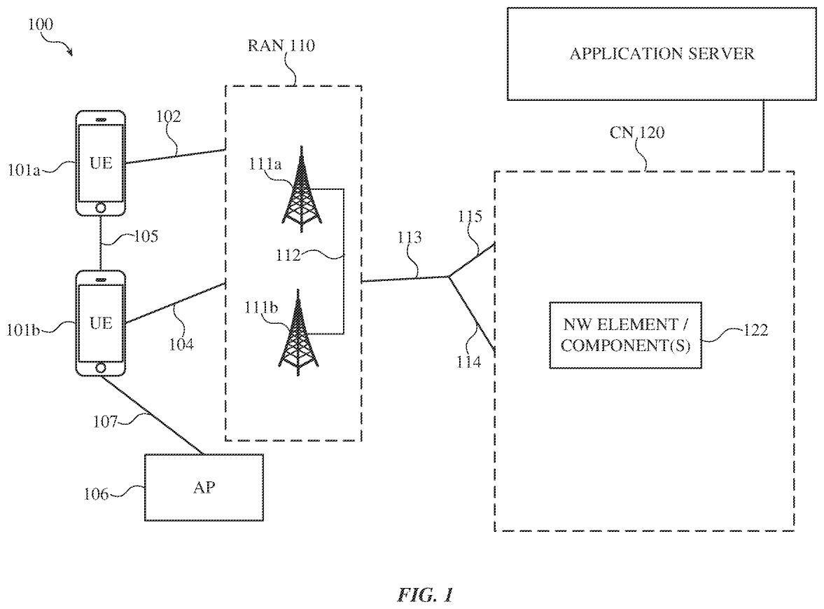

FIG. 1 illustrates an example architecture of a wireless communication system 100 of a network that includes UE 101a and UE 101b (collectively referred to as “UEs 101” or generally referred to as “UE 101”), a radio access network (RAN) 110, and a core network (CN) 120. In other aspects, the UE 101b is referred to as another UE 101b. The UEs communicate with the CN 120 by way of the RAN 110. In aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G system, and the term “E-UTRAN” or the like can refer to a RAN 110 that operates in an LTE or 4G system. The UEs 101 utilize connections 102 and 104, in some aspects, connections 102 and 104 are referred to as channels, each of which comprises a physical communication interface/layer. Connections 102 and 104 (also referred to as channels) can facilitate one or more of licensed or unlicensed communication bands between the UE 101 and the RAN 110.

Alternatively, or additionally, each of the UEs 101 can be configured with dual connectivity (DC) as a multi-RAT or multi-Radio Dual Connectivity (MR-DC), where a multiple Rx/Tx capable UE may be configured to utilize resources provided by two different nodes (e.g., 111a, 111b, 112, or other network nodes) that can be CONNECTED via non-ideal backhaul, one providing NR access and the other one providing either E-UTRA for LTE or NR access for 5G, for example.

Alternatively, or additionally, each of the UEs 101 can be configured in a CA mode where multiple frequency bands are aggregated amongst component carriers (CCs) to increase the data throughput between the UEs 101 and the BS 111a and BS 111b. For example, UE 101a can communicate with BS 111a according to the CCs in CA mode. Furthermore, UE 101a can communicate with BS 111 in a DC mode simultaneously and additionally communicate with each node of BS 111 in the CA mode.

In this example, the connections 102 and 104 are illustrated as an air interface to enable communicative coupling. In aspects, the UEs 101 can directly exchange communication data via a ProSe interface. The ProSe interface can alternatively be referred to as a sidelink (SL) interface 105 and can comprise one or more logical channels. In other aspects, the ProSe interface can be a direct (peer-to-peer) communication.

The RAN 110 can include one or more access nodes (AN) or RAN nodes, also referred to as base stations (BS) or BS 111a and BS 111b (collectively referred to as “RAN nodes” or “BSs” generally referred to as “RAN node” or “BS”) that enable the connections 102 and 104. As used herein, the terms “access node,” “access point,” or the like can describe equipment that provides the radio baseband functions for data and/or voice connectivity between a network and one or more users. These access nodes can be referred to as a base station (BS), next generation base station (gNBs), RAN nodes, evolved next generation base station (eNBs), NodeBs, RSUs, Transmission Reception Points (TRxPs) or TRPs, and so forth. As such, the BS can be referred to herein as BS 111a, BS 111b, collectively as BSs or generally as BS 111.

In aspects where the wireless communication system 100 is a 5G or NR system, the interface 112 can be an Xn interface. The Xn interface is defined between two or more base stations (BSs), for example, BS 111, (e.g., two or more gNBs, RAN nodes, and the like) that connect to 5GC, between a BS 111 (e.g., RAN node or a gNB) connecting to 5GC and an eNB, and/or between two eNBs connecting to 5GC.

The UE 101 and the BS 111 (i.e., or RAN node) may utilize a Uu interface to exchange control plane data via a protocol stack comprising the PHY layer (e.g., layer 1 (L1)), the MAC layer (e.g., layer 2 (L2)), the RLC layer, the PDCP layer, and the radio resource control (RRC) layer (e.g., layer 3 (L3)). The Uu interface can be one or more of connections 102 and 104.

UEs 101 may communicate and establish a connection with one or more other UEs via the SL interface 105, or more than one SL interface 105, each of which may comprise a physical communications interface/layer. UEs 101 may be configured to discover one another, negotiate wireless resources between one another, and establish connections between one another, without intervention or communications involving the BS or another type of network node. In some implementations, discovery, authentication, resource negotiation, registration, etc., may involve communications with BS 111 or another type of network node.

In aspects, the CN 120 can be a 5GC (referred to as “5GC 120” or the like), and the RAN 110 can be CONNECTED with the CN 120 via interface 113, which can be referred to as a next generation (NG) interface. In aspects, the NG interface can be split into two parts, a NG user plane (NG-U) interface 114, which carries traffic data between the BS 111 (i.e., or RAN nodes) and a User Plane Function (UPF), and the S1 control plane (NG-C) interface 115, which is a signaling interface between the BS 111 (i.e., or RAN nodes) and Access and Mobility Management Functions (AMFs).

In aspects, where CN 120 is an evolved packet core (EPC) (referred to as “EPC 120” or the like), the RAN 110 can be CONNECTED with the CN 120 via an S1 interface (indicated by NG-U interface 114). In aspects, the interface 113 can be split into two parts, an S1 user plane (S1-U) interface, which carries traffic data between the BS 111 (e.g., one or more RAN nodes) and the S-GW, and the S1-MME interface, which is a signaling interface between the BS 111 (i.e., or RAN nodes) and MMEs.

The RAN 110 is shown to be communicatively coupled to a core network—in this aspect, CN 120. The CN 120 can comprise a plurality of network components 122 (or network devices), which are configured to offer various data and telecommunication services to customers/subscribers (e.g., users of UEs 101) that are CONNECTED to the CN 120 via the RAN 110.

The UE 101a or the BS 11a can initiate a sensing service request that is passed to the SF through the BS 111a to begin a locally integrated sensing procedure. The SF can interact with various network functions of the CN 120 and the BS 111a and UE 101a for sensing procedures based on sensing objectives. The SF can be locally integrated in the BS 111a where the SF performs data processing based on sensing procedures performed by the UE 101a or the BS 111a. The SF can generate a sensing response with a sensing report and sensing commands based on processing the sensing data, and transmit the sensing response locally for the UE 101a and the BS 111a or centrally to the CN 120. One or more of the UE 101a, the BS 111a, or CN 120 components can use the sensing response for additional sensing procedures based on sensing objectives.

### Locally Integrated Sensing by a Sensing Function

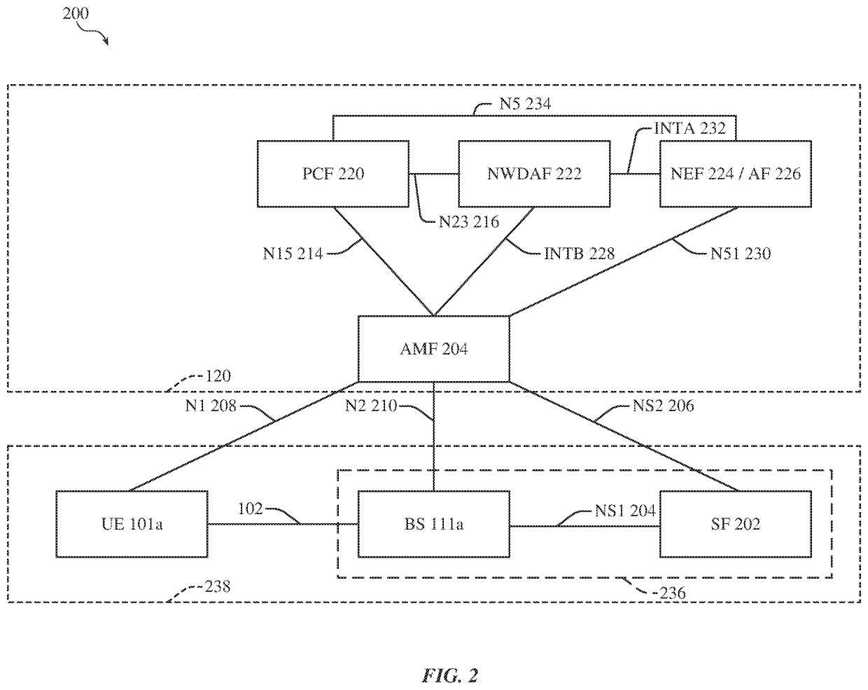

FIG. 2 illustrates a non-roaming architecture 200 with a sensing function (SF) 202 that is locally integrated and associated interfaces between local network components 238 and CN 120 components. In non-roaming architecture 200, the UE 101a can be the UE 101a FIG. 1, the BS 111a can be the BS 111a of FIG. 1. The SF 202 can provide locally integrated sensing with local network components 238, where the SF 202 can communicate with the CN 120 components through an AMF 204 and the SF 202 can communicate with local network components 238 through the BS 111a. UE 101a can operate in a non-roaming architecture (e.g., non-roaming architecture 200) of a wireless network or a roaming architecture of the wireless network. The UE 101a operating in the non-roaming architecture 200 can concurrently access two data networks, a local data network (e.g., local network components 238), and a central data network (e.g., CN 120 components). The UE 101a operating in a roaming architecture may have limited access to the local data network or central data network according to a differing arrangement of network functions to support roaming features, and limited access to some network functions relative to the non-roaming architecture 200. For example, UE 101a access to CN 120 may be limited by a security edge protection proxy (SEPP) while the UE 101a is roaming where some non-roaming network functions or users are isolated, or protected, from the roaming UE 101a by the SEPP. Solutions provided herein relate to the non-roaming architecture 200 where the SF 202 is not limited by the SEPP, protected, or isolated from CN 120 network functions or other UEs.

The CN 120 components that the SF 202 interacts with include the AMF 204, a policy control function (PCF) 220, a network data analytics function (NWDAF) 222, a network exposure function (NEF) 224, and an application function (AF) 226. The AMF 204 provides an interface to pass sensing related information to the SF 202 for sensing configuration and sensing data processing. The PCF 220, NWDAF 222, NEF 224, and AF 226 provide sensing related information including one or more of sensing authentication information, sensing policy information, sensing management information, sensing requirement information, sensing application information, wireless network data analysis for sensing, network capability for sensing, and the like.

The AMF 204 is a network element within the CN 120 that primarily provides registration management, connection management, reachability management, mobility management and next generation application protocols (NGAP) signaling. The AMF 204 provides critical services in communications between the CN 120 to the UE 101a and the BS 111a. As such, the AMF 204 can provide integrated sensing signaling for the SF 202 between the CN 120 components, UE 101, BS 111a, and SF 202.

The PCF 220 provides policies associated with mobility management and session management. Mobility management can be associated with UE 101a mobility in radio resource control (RRC) states (e.g., Idle and Connected modes). Session management policies can be associated with mechanisms to manage subscriber limits and quality of service (QoS) of a packet data network (PDN) session. As such, the PCF 220 can provide policy related information for sensing services and functions associated with the SF 202. For example, policy data from the PCF 220 can be used by the SF 202 to determine a sensing configuration or used by the SF 202 when processing sensing data. As such, the PCF 220 can provide sensing related policy information to SF 202.

The NWDAF 222 can establish interfaces and protocols one or more components of the CN 120 including the PCF 220, AMF 204, NEF 224, and AF 226, and can retrieve data from the CN 120 components and perform analysis on the retrieved data. The NWDAF 222 can provide information including analysis of data or instructions from one or more CN 120 components for the SF 202. As such, the NWDAF 222 can provide sensing related data to the SF 202.

The NEF 224 provides information regarding the capability of network functions within the wireless network to external network functions or applications. For example, the NEF 224 can report the network monitoring capability of the wireless network to external applications. As such, the NEF 224 can provide capability information of the wireless network for the SF 202 to determine the sensing configuration or to process sensing data.

The AF 226 can be configured as an application server providing application support for services and information. For example, the AF 226 can provide application information for video streaming. As such, the AF 226 can provide application information, or application sensing information, from the wireless network to the SF 202 to determine the sensing configuration or to process sensing data.

The CN 120 components provide the sensing related information to the SF 202 through the AMF 204 by various interfaces. CN 120 component interfaces are shown in the non-roaming architecture 200 as reference points (also referred to as point-to-point interfaces, or interfaces), between network functions. Reference points can represent logical connections between wireless network functions, elements, and components. N51 230 is the reference point between the AMF 204 and the NEF 224. In some aspects, the AF 226 communicates to the AMF 204 through the NEF 224 and N51. INTA 232 is the interface between the NWDAF 222 and the NEF 224, and can be the interface between the NWDAF 222 and the AF 226. INTB 228 is the interface between the NWDAF 222 and the AMF 204. N23 216 is the reference point between the NWDAF 222 and the PCF 220. N5 234 is the reference point between one or more of the NEF 224 or the AF 226 and the PCF 220.

The AMF 204 also provides a connection between the CN 120 components and local network components 238 through reference points. N1 208 is a reference point between UE 101a and the AMF 204. N2 210 is a reference point between BS 111a and the AMF 204. Aspects of the present disclosure present new interfaces including a first sensing function interface (NS1) 204 and a second sensing function interface (NS2) 206 from the SF 202. NS1 204 is a reference point between the BS 111a and the SF 202. NS2 206 is a reference point between AMF 204 and SF 202. As such, the SF 202 interacts with CN 12 components indirectly through the AMF 204 via NS2 206. In some aspects, NS1 204 is referred to as a base station/sensing function interface, or BS/SF interface. In some aspects, the NS2 206 is referred to as an access and mobility function/sensing function interface, or AMF/SF interface.

NS1 204 provides sensing data signaling, and provides sensing processing results that can include a sensing processing report or sensing commands between the BS 111a and the SF 202, and is discussed further herein. NS2 206 provides sensing control signaling (e.g., sensing related policy information, sensing relation application information, sensing related data, etc. . . . ), sensing service request signaling, sensing service response signaling, and sensing processing result signaling between the AMF 204 and the SF 202, and is discussed further herein.

Wireless networks can include a user plane and a control plane. The user plane can transfer application data and the control plane can transfer signaling messages. The SF 202 can operate in both the control plane and the user plane. For example, SF 202 can use NS1 204 in the control plane or the user plane and NS2 206 in the control plane. The SF 202 can receive sensing data in the user plane from the BS 111a. Furthermore, the SF 202 can transmit a sensing response including data reporting from sensing data in the control plane or the user plane to the AMF 204.

The SF 202 is located outside of the CN 120 and is locally integrated with the local network components 238. In some aspects, the SF 202 is located within the BS 111a or an edge (e.g. edge server). A dashed box 236 surrounding BS 111a and SF 202 represents that the SF 202 can be integrated in the BS 111a.

The SF 202 provides locally integrated sensing services such as retrieving sensing data, processing sensing data, and transmitting sensing data results and interacts directly with the BS 111a and AMF 204, indirectly with the UE 101a through the BS 111a, and indirectly with the PCF 220, NWDAF 222, NEF 224, and AF 226 through the AMF, and is discussed further herein. By locally integrating the SF 202, sensing data can be split among local components such as terminals, BS, and edge servers, for example, by a plurality of SFs (e.g., where the SF 202 is located in the BS 111a indicated by the dashed box 236). Local integration of the SF 202 can enable ISC for wireless networks while increasing QoS by minimizing CN 120 network overhead and latency of sensing signaling by locating the SF 202 within the local network components 238 relative to central integration of the SF 202 in the CN 120.

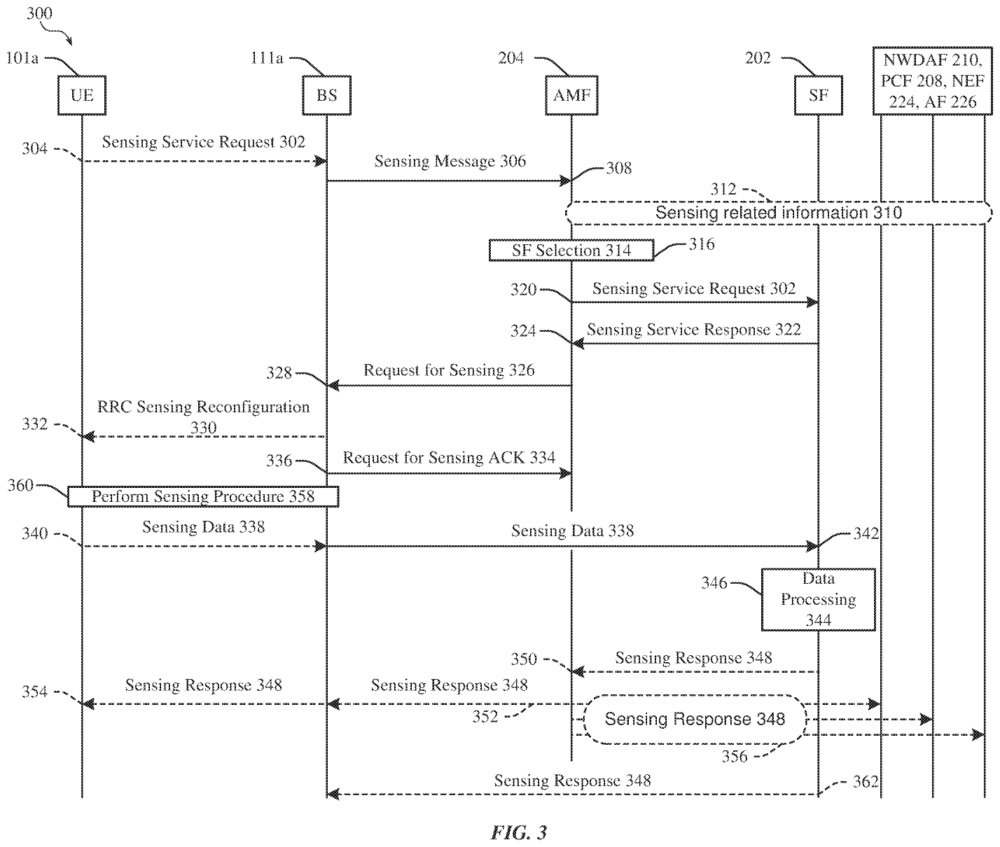

FIG. 3 illustrates a diagram 300 of a wireless network with integrated sensing signaling between various network functions and components, where the SF 202 is locally integrated. Diagram 300 shows sensing signaling between the UE 101a, BS 111a, AMF 204, SF 202, NWDAF 210, PCF 208, NEF 224, and AF 226, where the SF 202 is locally integrated with the local network components 238 of FIG. 2. Where FIG. 2 illustrates the non-roaming architecture 200, the diagram 300 of FIG. 3 shows the sensing signaling between the components of the non-roaming architecture 200. Now referring to FIGS. 2 and 3 concurrently. In some aspects, the CN 120 components are referred to as entities herein. For example, the AMF 204 can be referred to as an AMF entity, the SF 202 as a SF entity, the NWDAF 210 as a NWDAF entity, the PCF 208 as a PCF entity, the NEF 224 as a NEF entity, and the AF 226 as an AF entity.

The UE 101a can send a sensing service request 302 to the BS 111a at 304 over connection 102, wherein the sensing service request is associated with a sensing procedure. The sensing service request 302 can tell the network that the UE 101a requests permission to measure or obtain sensing data, and perform an uplink (UL) transmission with sensing data. Alternatively, the sensing service request 302 can be transmitted in response to a network sensing request from the BS 111a or the AMF 204. For example, the UE 101a can receive a paging request or a notification message associated with sensing from the CN 120, and transmit the sensing service request 302 at 304 in response to the paging request or the notification message.

The BS 111a can receive the sensing service request 302 at 304 and can send a sensing message 306 to the AMF 204 at 308 over N2 210. The Sensing message 306 can include a set of parameters and the sensing service request 302 from the UE 101a. The set of parameters indicate to the AMF 204 identity and location information of one or more of the BS 111a or the UE 101a. The identity and location information can be used by the AMF 204 in selecting a SF at 316 and discussed further herein. Specifically, the set of parameters can include sensing related elements including at least one of a serving temporary mobile subscription identifier (S-TMSI), a public land mobile network (PLMN) ID, location information, establishment cause, or user equipment (UE) context request.

In an alternative aspect, the BS 111a, rather than the UE 101a, initiates the sensing service request 302. As such, the BS 111a determines to generate a sensing service request 302 and transmit the Sensing message 306 with the sensing service request 302. As such, the sensing service request 302 can be UE associated, or non-UE associated, or BS associated, depending on the specific sensing scenarios or objectives identified by the UE 101a or the BS 111a, or network service request (e.g., paging request or notification message).

In another alternative aspect, the UE 101a can send the sensing service request 302 directly to the AMF 204 (not pictured), rather than sending the sensing service request 302 to the AMF 204 through the BS 111a at 304 and 308. As such, the UE 101a can generate a sensing message 306 that includes set of parameters and the sensing service request 302 generated by the UE 101a.

The sensing service request 302 can be comprised in an access network (AN) message, where the AN message includes AN parameters and the sensing service request. The sensing service request 302 can include one or more sensing service request elements including an extended protocol discriminator, security header type, spare half octet, serving temporary mobile subscription identifier (S-TMSI), message ID, or service type, where the sensing service request elements are associated with local sensing operations of the UE 101a or the BS 111a. The message ID can be a sensing service request specific ID with specific values dedicated for the sensing service request 302. The service type can be a sensing service type specific to sensing service request, with specific values dedicated for the sensing service type request.

In some aspects, the UE 101a or the BS 111a can generate and transmits a plurality of sensing service requests for a plurality of independent sensing objectives. Sensing objectives can be application dependent, for example, based on sensing objectives associated with a wearable device, a vehicle, smart home, health monitor, or the like. Whether the UE 101a or the BS 111a generates the sensing service request 302, or transmits the sensing message 306 or sensing message, or transmits a plurality of sensing service requests is application dependent.

At 316, the AMF 204 can make a SF selection 314 based on the received sensing message 306 at 308. Before making the SF selection 314, the AMF 204 can receive sensing related information 310 at 312. The sensing related information 310 can include one or more of sensing authentication information, sensing policy information, sensing management information, sensing requirement information, sensing application information, wireless network data analysis for sensing, network capability for sensing, and the like. The sensing related information 310 is sent to the AMF 204 from one or more of the NWDAF 210, PCF 208, NEF 224, or AF 226. In some examples, the AMF 204 receives the sensing related information 310 in response to the AMF 204 sending a sensing information request to the CN 120 components. After receiving the sensing related information 310, the AMF 204 can transmit the sensing related information 310 to the SF 202 at 312. The sensing related information 310 can be used to generate sensing authentication information by the SF 202 for the UE 101a or the BS 111a. As such, the SF 202 can generate a sensing authentication command for the UE 101a or the BS 111a based on the sensing related information, where a sensing service response 322 is generated by the SF 202 at 324 to include the sensing authentication command. Furthermore, the SF 202 can perform data processing 344 at 346 of a sensing data 338 based on the sensing related information 310. How the AMF 204 and the SF 202 use the sensing related information 310 is dependent on the sensing objectives.

At 316, the AMF 204 makes a SF selection 314. The AMF 204 may be able to select one or more of a plurality of SFs for local sensing data processing based on at least one of the sensing message 306, or the sensing related information 312. For example, the AMF 204 may select a SF 202 based on the location or identity information, device capability, or sensing service type indicated by the sensing message 306, or based on sensing requirements indicated by the sensing related information 310. The location information of the sensing message 306 may identify the location of the UE 101a or BS 111a that generated the sensing service request 302. The AMF 204 may determine to select SF 202 that is located with local network components 238 comprising UE 101a or BS 111a based on the location information. As such, the AMF 204 can select a locally integrated SF based on at least one of the sensing message 306, or sensing related information 310 to enable locally integrated sensing services. The AMF 204 can make the SF selection 314 at 316 based on specific sensing objectives that dictate features from the sensing message 306, or the sensing related information 310 are used for the SF selection 314.

At 320 the AMF 204 transmits, by the NS2 206, the sensing service request 302 to the selected SF, for example, SF 202. As such, the AMF 204 forwards the sensing service request 302 comprised in the sensing message 306. After the SF 202 receives the sensing service request 302 at 320, the SF 202 transmits a sensing service response 322 to the AMF 204 at 324. The sensing service request 302 received by the SF 202 indicates that the SF 202 is the selected SF for integrated sensing services associated with the sensing service request 302. Furthermore, the sensing service request 302 provides the SF 202 with the sensing service request elements where the SF 202 can perform data processing 344 at 346 based on the sensing service request elements.

At 324, the SF 202 transmits, by the NS2 206, a sensing service response 322 to the AMF 204. Sensing service response 322 indicates an acknowledgement to the AMF 204 that the sensing service request 302 was received by the SF 202 at 320. Furthermore, the sensing service response 322 indicates to the AMF 204 that the SF 202 is configured to provide integrated sensing services associated with the sensing service request 302. The sensing service response 322 can include a sensing configuration information that can be used by one or more of AMF 204, the BS 111a or the UE 101a. For example, the AMF 204 may determine, based on the sensing configuration information, to instruct multiple BSs or multiple UEs to perform the sensing procedure 358, and thus transmit the sensing configuration information to said devices accordingly. The BS 111a and the UE 101a can use the sensing configuration information to perform the sensing procedure 358.

The sensing procedure 358 can be based on sensing objectives. The sensing procedure 358 can include one or more measurement and interface functions based on sensing objectives. For example, the BS 111a or the UE 101a can interface with a dedicated sensor connected to the BS 111a or the UE 101a, and receive sensing information from the dedicated sensor. In other examples, the dedicated sensor is integrated with the BS 111a or the UE 101a. For example, the dedicated sensor can be a pedometer sensor integrated in a UE 101a device, or located remotely (e.g., located in a smart watch), and the UE 101a can interface with the pedometer sensor, and gather pedometer data from the pedometer sensor. The pedometer sensor data can be the sensing data, or the pedometer sensor data can be combined with other data from the UE 101a to generate the sensing data 338. Furthermore, the dedicated sensor can be associated with a vehicle, smart sensor (e.g., smart home, thermostat, humidity/temperature sensor, commercial sensors, or the like), manufacturing equipment, consumer device, or the like. In other examples, the sensing procedure 358 includes frequency spectrum measurements from sensors, for example, radar measurements, signal or noise measurements, channel occupancy measurements, or the like, from one or more of the UE 101a, the BS 111a, or the dedicated sensor. The sensing objectives associated with the request for sensing 326 can determine what measurements are performed by the UE 101a, BS 111a, or the dedicated sensor, and can determine what sensing data 338 is generated based on the measurements. For example, the sensing procedure 358 includes performing measurements associated with the sensing objective to generate the sensing data. In another example, the sensing procedure 358 includes establishing an interface with the dedicated sensor, instructing the dedicated sensor to perform measurements based on the sensing objective, and generating the sensing data based on the measurements performed by the dedicated sensor.

At 328, the AMF 204 transmits a request for sensing 326, by the N2 210, to the BS 111a. The request for sensing 326 message indicates a request to the BS 111a or the UE 101a to perform a sensing operation. The sensing operation is associated with the sensing service request 302 and can be based on sensing objectives. The request for sensing 326 can include sensing parameters including one or more of sensing configuration information, a security context, core network assistance information, UE capability parameters, and connection or mobility parameters. The UE 101a or the BS 111a can use the sensing parameters of the request for sensing 326 to configure a sensing procedure at 360. The UE capability parameters are generated by the UE 101a and signaled for the AMF 204 at 304. The security context, core network assistance information, and the connection or mobility parameters are N2 210 signaling parameters and include parameters received by the AMF 204 in the sensing message 306 or include parameters generated by the AMF 204 for the request for sensing 326. The connection and mobility parameters can include one or more of a mobility restriction list, timing advances (TAs), list of recommended cells, BS or RAN node identifiers. The UE capability parameters can indicate a radio capability of the UE 101a and an aggregated maximum bit rate (AMBR) for the UE 101a.

In an alternative aspect, the AMF 204 can transmit a request for sensing 326, by the N1 208, to the UE 101a, where the request for sensing 326 includes the same sensing related information as the request for sensing 326 for the BS 111a at 328. As such, the request for sensing 326 can be transmitted to one of the BS 111a or the UE 101a, based on which of the BS 111a or the UE 101a transmitted the sensing message 306 to the AMF 204. Or in other words, when the AMF 204 receives the sensing message 306 from the BS 111a, the AMF 204 may respond with the request for sensing 326 transmitted to the BS 111a at 328. Alternatively, when the AMF 204 receives the sensing message 306 from the UE 101a, the AMF 204 may respond with the request for sensing 326 to the UE 101a at 328 (not pictured). Additionally or alternatively, the AMF 204 may transmit the request for sensing to a plurality of UEs or a plurality of BS connected to the AMF 204 when the AMF 204 determines that more than one device (e.g., UEs or BSs) are configured for a sensing procedure.

In some aspects, where the request for sensing 326 is for the UE 101a, the BS 111a can generate a RRC sensing reconfiguration 330 or RRC sensing configuration message for the UE 101a after receiving the request for sensing 326. The BS 111a can transmit the RRC sensing reconfiguration 330 message at 332. As such, the BS 111a uses a RRC interface with the UE 101a to configure the UE 101a with the sensing requirements according to the request for sensing 326. The RRC sensing reconfiguration 330 message includes the request for sensing 326.

At 336, the BS 111a transmits a request for sensing acknowledgement 334 to the AMF 204 in response to receiving the request for sensing 326 from the AMF 204. The request for sensing acknowledgement 334 indicates to the AMF 204 that the request for sensing 326 was received at 328 and that the BS 111a or the UE 101a is configured to perform the sensing procedure 358 according to the request for sensing 326.

At 360, the UE 101a or the BS 111a performs the sensing procedure 358. The UE 101a performs the sensing procedure at 360 according to the RRC sensing reconfiguration 330 message, or the BS 111a performs the sensing procedure at 360 according to the request for sensing 326 at 328. The sensing procedure is based on sensing objectives as described herein. Sensing data 338 is generated based on performing the sensing procedure 358 at 360 by either the UE 101a or the BS 111a.

At 340, the sensing data 338 is transmitted from the UE 101a to the BS 111a by RRC signaling or user plane signaling. After the BS 111a receives the sensing data 338 from the UE 101a at 340, the BS 111a can transmit, by the NS1 204 interface, the sensing data 338 to the SF 202 at 342. In an alternative aspect, the BS 111a generates the sensing data according to the sensing procedure at 360, and the sensing data 338 transmitted to the SF 202 at 342 is the sensing data 338 generated by the BS 111. In some aspects, the sensing data 338 can be transmitted to the SF 202, by the NS1 204, by the user plane or the control plane.

At 346, the SF 202 performs data processing 344. Data processing includes processes the sensing data 338 received at 342. As such, the SF 202 performs locally integrated data processing at 346 within the local network components 238, for example, where the SF 202 can be located within the BS 111a. In some aspects, the data processing 344 includes processing the sensing data 338 with the sensing related information 310. In other aspects, the data processing 344 includes processing the sensing data 338 without the sensing related information 310, for example, if the sensing related information 310 is not received at 312 or the sensing objectives to not include processing the sensing data 338 with the sensing related information 310. As such, the SF 202 can determine to perform data processing 344 depending on the sensing objectives. When the SF 202 does not receive sensing related information 310 at 312, the SF 202 performs data processing 344 at 346 with the sensing data 338 and without the sensing related information 310.

At 350, the SF 202 can generate and transmit, by the NS2 206, a sensing response 348 based on the data processing 344 to the AMF 204. As such, the AMF 204 receives the sensing response 348 in response to transmitting the sensing service request 302. The sensing response 348 includes one or more of a sensing processing report or sensing commands. The sensing processing report can include results of the data processing 344 based on at least the sensing data 338. The sensing commands can include additional sensing signaling or sensing operations based on the sensing processing report. The sensing processing report and the sensing commands are specific to the sensing objectives as described herein. In some examples, the SF 202 does not transmit the sensing response 348 when the data processing 344 does not result in data that meets a reporting criteria or threshold. The reporting criteria or threshold is specific to the sensing objectives as described herein.

Depending on the contents of the sensing response 348, the SF 202 can indicate to the AMF 204 retransmission of the sensing response 348, or the AMF 204 can determine to re-transmit the sensing response 348 to one or more of the BS 111a at 352, or the NWDAF 210, PCF 208, NEF 224, or AF 226 at 356. The other network components can use the sensing processing report or sensing commands for subsequent functions according to sensing objectives as described herein.

As such, the BS 111a can receive the sensing response 348 from the AMF 204 at 352 in response to transmitting the sensing data 338 at 342. The UE 101a can receive the sensing response 348 from the BS 111a at 354 in response to transmitting the sensing data 338 at 340. One or more of the NWDAF 210, PCF 208, NEF 224, or AF 226 can receive the sensing response 348 at 356 based on the data processing 344 at 346 or based on the sensing related information 310 at 312.

At 362, the SF 202 can transmit the sensing response 348, by NS1 204, to the BS 111a directly. In this aspect, signaling is minimized as the sensing response 348 is not transmitted through an intermediator like the AMF 204. The SF 202 can determine, based on the sensing response 348, that the sensing response 348 can be used by the local network components 238, and transmit the sensing response 348 locally accordingly.

Aspects described herein enhance wireless networks by providing solutions for locally integrated sensing, where, for example, the SF 202 is located in the BS 111a. A first sensing function interface (NS1) 204 is introduced between the SF 202 and the BS 111a and a second sensing function interface (NS2) 206 is introduced between the SF 202 and the AMF 204 to enable local integration of the SF 202 local network components 238. Signaling and procedures between the local network components 238 and the CN 120 components are presented herein for integrated sensing and communication. By integrating the SF 202 locally, solutions provided herein the wireless network is enabled with integrated sensing and communicating that increases QoS by minimizing CN 120 network overhead and latency of sensing signaling by locating relative to central integration of the SF 202 in the CN 120.

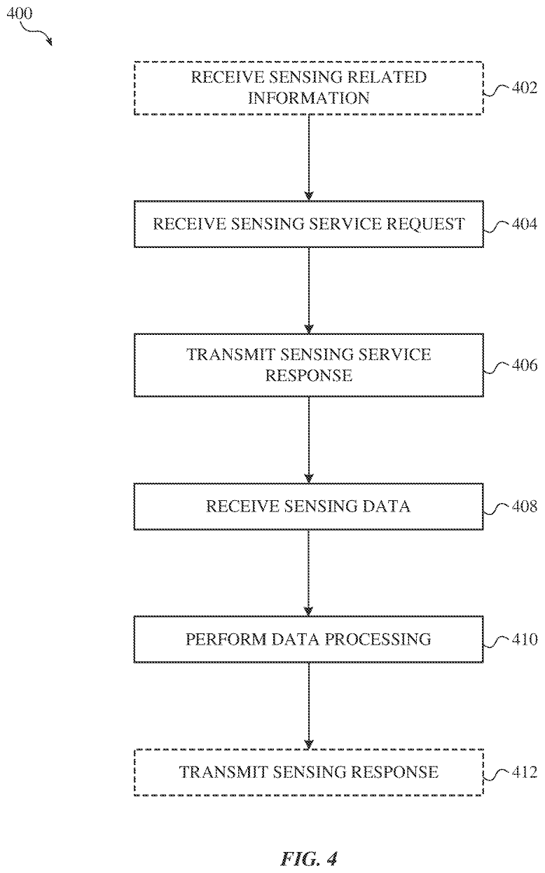

FIG. 4 illustrates a flow diagram of an example method 400 by which a SF performs locally integrated sensing functions. The example method 400 may be performed, for example, by the SF 202 of FIG. 3.

At 402, the method includes optionally receiving sensing related information. The sensing related information can include one or more of sensing authentication information, sensing policy information, sensing management information, sensing requirement information, sensing application information, wireless network data analysis for sensing, network capability for sensing, and the like. FIG. 3 at 312 corresponds to some aspects of act 402.

At 404, the method includes receiving, by a NS2 interface, a sensing service request. The sensing service request can include one or more sensing service request elements including an extended protocol discriminator, security header type, spare half octet, S-TMSI, message ID, or service type, where the sensing service request elements are associated with local sensing operations of a UE or a BS. FIG. 3 at 320 corresponds to some aspects of act 404.

At 406, the method includes transmitting, by the NS2 interface, a sensing service response. The sensing service response is an acknowledgement of receiving the sensing service request and indicates that the SF is configured to provide integrated sensing services associated with the sensing service request. FIG. 3 at 324 corresponds to some aspects of act 406.

At 408, the method includes receiving, by a NS1 interface, sensing data. The sensing data is generated by the UE or the BS based on the sensing service response. FIG. 3 at 342 corresponds to some aspects of act 408.

At 410, the method includes performing data processing on the sensing data. In some aspects, the data processing is performed based on the sensing data and the optionally received sensing related information from act 402. The data processing is performed locally, for example, where the SF may be integrated with a BS. FIG. 3 at 346 corresponds to some aspects of act 410.

At 412, the method optionally includes transmitting a sensing response after performing the data processing. The sensing response includes one or more of a sensing processing report or sensing commands. The sensing processing report can include results of the data processing based on at least the sensing data. The sensing commands can include additional sensing signaling or sensing operations based on the sensing processing report that can be used by other network components for subsequent sensing procedures. FIG. 3 at 350 corresponds to some aspects of act 412.

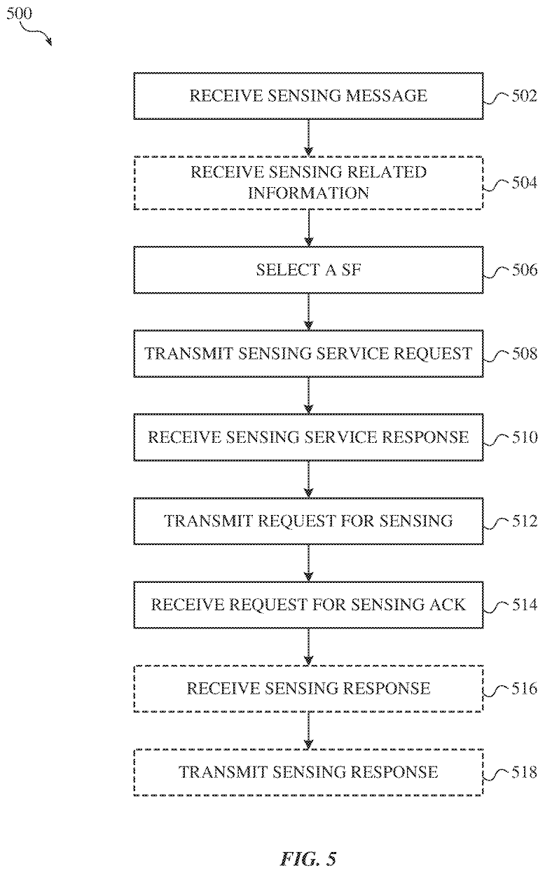

FIG. 5 illustrates a flow diagram of an example method 500 by which an AMF supports locally integrated sensing functions by sensing signaling and sensing messaging. The example method 500 may be performed, for example, by the AMF 204 of FIG. 3.

At 502, the method includes receiving a sensing message. The sensing message can be from a BS or a UE. The sensing message can initiate a local integrated sensing procedure. The sensing service request can include one or more sensing service request elements including an extended protocol discriminator, security header type, spare half octet, S-TMSI, message ID, or service type, where the sensing service request elements are associated with local sensing operations of a UE or a BS. FIG. 3 at 308 corresponds to some aspects of act 502.

At 504, the method includes optionally receiving sensing related information. The sensing related information can include one or more of sensing authentication information, sensing policy information, sensing management information, sensing requirement information, sensing application information, wireless network data analysis for sensing, network capability for sensing, and the like. FIG. 3 at 312 corresponds to some aspects of act 504.

At 506, the method includes selecting a SF. The SF can be selected based on the received sensing message. Additionally or alternatively, the SF can be selected based on the optionally received sensing related information. Additionally or alternatively, the SF can be selected based on sensing objectives. FIG. 3 at 316 corresponds to some aspects of act 506.

At 508, the method includes transmitting, by a NS2 interface, a sensing service request. The sensing service request can include one or more sensing service request elements including an extended protocol discriminator, security header type, spare half octet, S-TMSI, message ID, or service type, where the sensing service request elements are associated with local sensing operations of a UE or a BS. FIG. 3 at 320 corresponds to some aspects of act 508.

At 510, the method includes receiving, by the NS2 interface, a sensing service response. The sensing service response is an acknowledgement of the transmitted sensing service request and indicates that the selected SF is configured to provide integrated sensing services associated with the sensing service request. FIG. 3 at 324 corresponds to some aspects of act 510.

At 512, the method includes transmitting, a request for sensing. The request for sensing indicates a request for the BS or the UE to perform a sensing operation. The request for sensing can include can include sensing parameters including one or more of sensing configuration information, a security context, core network assistance information, UE capability parameters, and connection or mobility parameters. FIG. 3 at 328 corresponds to some aspects of act 512.

At 514, the method includes receiving a request for sensing acknowledgement. The request for sensing acknowledgement is an acknowledgement that the request for sensing was received, and one of the UE or the BS will perform the sensing procedure associated with the request for sensing. FIG. 3 at 336 corresponds to some aspects of act 514.

At 516, the method includes optionally receiving, by the NS2 interface, a sensing response. The sensing response includes a sensing processing report data from sensing data generated by the BS or the UE based on the request for sensing. Furthermore, the sensing response can include sensing commands. FIG. 3 at 350 corresponds to some aspects of act 516.

At 518, the method includes optionally transmitting the sensing response. After receiving the sensing response, the method can include determining to re-transmit the sensing response to one or more network components, such as the BS, NWDAF, PCF, NEF, or AF. FIG. 3 at 352 and 356 correspond to some aspects of act 518.

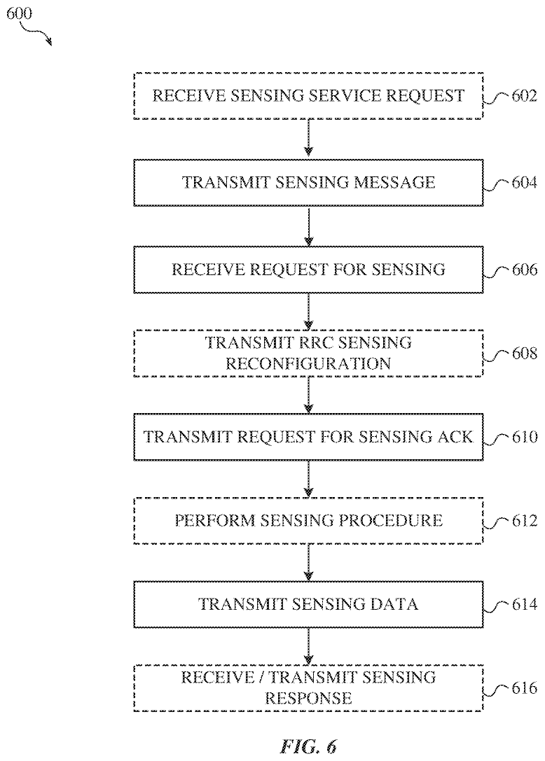

FIG. 6 illustrates a flow diagram of an example method 600 by which a BS performs locally integrated sensing functions by perform sensing signaling, sensing messaging, and sensing procedures. The example method 600 may be performed, for example, by the BS 111a of FIG. 3.

At 602, the method includes optionally receiving a sensing service request. The sensing service request can include one or more sensing service request elements including an extended protocol discriminator, security header type, spare half octet, S-TMSI, message ID, or service type, where the sensing service request elements are associated with local sensing operations of a UE or a BS. FIG. 3 at 304 corresponds to some aspects of act 602.

At 604, the method includes transmitting a sensing message. The sensing message can include the sensing service request from 602. In other aspects, the method includes generating the sensing service request, and transmitting the sensing message with the sensing service request. The sensing message can initiate a local integrated sensing procedure. The sensing service request can include one or more sensing service request elements including an extended protocol discriminator, security header type, spare half octet, S-TMSI, message ID, or service type, where the sensing service request elements are associated with local sensing operations of a UE or a BS. FIG. 3 at 308 corresponds to some aspects of act 604.

At 606, the method includes receiving a request for sensing in response to transmitting the sensing message 306. The request for sensing indicates a request for the BS or the UE to perform a sensing operation. The request for sensing can include sensing parameters including one or more of sensing configuration information, a security context, core network assistance information, UE capability parameters, and connection or mobility parameters. FIG. 3 at 328 corresponds to some aspects of act 606.

At 608, the method includes optionally transmitting a RRC sensing reconfiguration or configuration. When the request for sensing is associated with a UE, the method includes generating the RRC sensing reconfiguration message that includes the request for sensing. FIG. 3 at 332 corresponds to some aspects of act 608.

At 610, the method includes transmitting a request for sensing acknowledgement. The request for sensing acknowledgement is an acknowledgement that the request for sensing was received, and one of the UE or the BS will perform the sensing procedure associated with the request for sensing. FIG. 3 at 336 corresponds to some aspects of act 610.

At 612, the method includes optionally performing a sensing procedure. The sensing procedure is performed when the request for sensing indicates that the BS is configured to perform the sensing procedure. Performing the sensing procedure includes generating sensing data. FIG. 3 at 360 corresponds to some aspects of act 612.

At 614, the method includes transmitting, by a NS1 interface, sensing data. In some aspects, the sensing data is first received, for example, received from a UE when the request for sensing includes a configuration for the UE to perform the sensing procedure. In this aspect, the method includes transmitting the sensing data received from the UE. In an alternative aspect, the sensing data is generated by the BS according to act 612. FIG. 3 at 340 and 342 correspond to some aspects of act 614.

At 616, the method includes optionally receiving a sensing response, and optionally transmitting the sensing response. The sensing response includes a sensing processing report data from sensing data generated by the BS or the UE based on the request for sensing. Furthermore, the sensing response can include sensing commands. FIG. 3 at 352 and 354 correspond to some aspects of act 616.

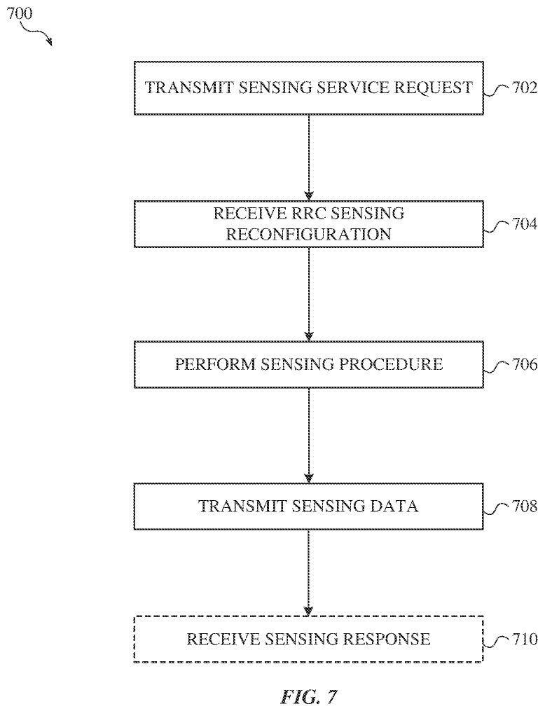

FIG. 7 illustrates a flow diagram of an example method 700 by which a UE performs locally integrated sensing functions by perform sensing signaling, sensing messaging, and sensing procedures. The example method 700 may be performed, for example, by the UE 101a of FIG. 3.

At 702, the method includes transmitting a sensing service request. The sensing service request can include one or more sensing service request elements including an extended protocol discriminator, security header type, spare half octet, S-TMSI, message ID, or service type, where the sensing service request elements are associated with local sensing operations of a UE. In some aspects, the sensing service request is transmitted to a BS. In other aspects, the sensing service request can be transmitted to an AMF. In this aspect, the method includes generating and transmitting a sensing message including the sensing service request. FIG. 3 at 304 corresponds to some aspects of act 702.

At 704, the method includes receiving a RRC sensing reconfiguration or configuration including a request for sensing. The RRC sensing reconfiguration is received in response to transmitting the sensing service request and includes a configuration for performing a sensing procedure. FIG. 3 at 332 corresponds to some aspects of act 704.

At 706, the method includes performing a sensing procedure. The sensing procedure is performed in response to receiving the RRC sensing configuration with a request for sensing. Performing the sensing procedure includes generating sensing data based on the RRC sensing configuration. FIG. 3 at 360 corresponds to some aspects of act 706.

At 708, the method includes transmitting sensing data. The sensing procedure performed at 706 results in the UE generating sensing data. The sensing data is transmitted so that the SF can locally process the sensing data. FIG. 3 at 340 corresponds to some aspects of act 708.

At 710, the method includes optionally receiving a sensing response. The sensing response includes a sensing processing report data from sensing data generated by the BS or the UE based on the request for sensing. Furthermore, the sensing response can include sensing commands. FIG. 3 at 354 corresponds to some aspects of act 710.

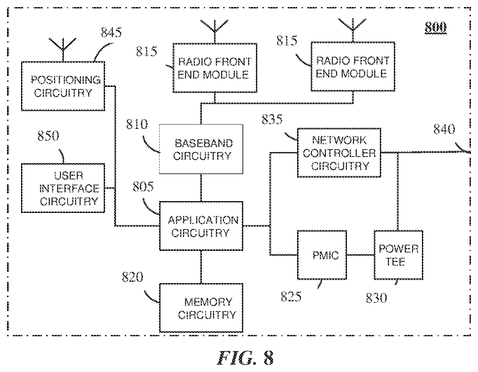

FIG. 8 illustrates an example of system 800 (also referred to as infrastructure equipment) in accordance with various aspects. The system 800 may be implemented as a base station, radio head, RAN node such as the BS 111, or BS 111a, or BS 111b of FIG. 1 and/or any other element/component/device discussed herein. In other examples, the system 800 could be implemented in or by a UE such as UE 101, or UE 101a, or UE 101b of FIG. 1. In yet other aspects, some features of the system 800 could be implemented in or by the BS 111a of FIG. 1.

The system 800 includes application circuitry 805, baseband circuitry 810, one or more radio front end modules (RFEMs) 815, memory circuitry 820 (including a memory interface), power management integrated circuitry (PMIC) 825, power tee circuitry 830, network controller circuitry 835, network interface connector 840, satellite positioning circuitry 845, and user interface 850. In some aspects, the device of system 800 may include additional elements/components/devices such as, for example, memory/storage, display, camera, sensor, or input/output (I/O) interface. In other aspects, the components/devices described below may be included in more than one device. For example, said circuitries may be separately included in more than one device for CRAN, vBBU, or other like implementations.

The baseband circuitry 810 can be used by the UE 101a to transmit the sensing service request 302, sensing message 306, receive the RRC sensing reconfiguration 330, perform sensing procedure 358, transmit sensing data 338, or receive sensing response 348. The baseband circuitry 810 can be used by the BS 111a to receive the sensing service request 302, transmit sensing message 306, receive the request for sensing 326, transmit RRC sensing reconfiguration 330, transmit the request for sensing acknowledgement 334, receive sensing data 338, transmit sensing data 338, receive sensing response 348, or transmit sensing response 348.

Application circuitry 805 includes circuitry such as, but not limited to one or more processors (or processor cores), processing circuitry, cache memory, and one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD) MultiMediaCard (MMC) or similar, Universal Serial Bus (USB) interfaces, Mobile Industry Processor Interface (MIPI) interfaces and Joint Test Access Group (JTAG) test access ports. The processors (or cores) of the application circuitry 805 may be coupled with or may include memory/storage elements/components/devices and may be configured to execute instructions stored in the memory/storage to enable various applications or operating systems to run on the system 800. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The processor(s) of application circuitry 805 may include, for example, one or more processor cores (CPUs), one or more application processors, one or more graphics processing units (GPUs), one or more reduced instruction set computing (RISC) processors, one or more Acorn RISC Machine (ARM) processors, one or more complex instruction set computing (CISC) processors, one or more digital signal processors (DSP), one or more field programmable gate array (FPGAs), one or more PLDs, one or more application-specific integrated circuits (ASICs), one or more microprocessors or controllers, or any suitable combination thereof. In some aspects, the application circuitry 805 may comprise, or may be, a special-purpose processor/controller to operate according to the various aspects herein. As examples, the processor(s) of application circuitry 805 may include one or more Apple® processors, Intel® processor(s); Advanced Micro Devices (AMD) Ryzen® processor(s), Accelerated Processing Units (APUs), or Epyc® processors; ARM-based processor(s) licensed from ARM Holdings, Ltd. such as the ARM Cortex-A family of processors and the ThunderX2® provided by Cavium™, Inc.; a MIPS-based design from MIPS Technologies, Inc. such as MIPS Warrior P-class processors; and/or the like. In some aspects, the system 800 may not utilize application circuitry 805, and instead may include a special-purpose processor/controller to process IP data received from an EPC or 5GC, for example.

User interface 850 may include one or more user interfaces designed to enable user interaction with the system 800 or peripheral component or device interfaces designed to enable peripheral component or device interaction with the system 800. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, etc. Peripheral component or device interfaces may include, but are not limited to, a nonvolatile memory port, a universal serial bus (USB) port, an audio jack, a power supply interface, etc.

The components or devices shown by FIG. 8 may communicate with one another using interface circuitry, that is communicatively coupled to one another, which may include any number of bus and/or interconnect (IX) technologies such as industry standard architecture (ISA), extended ISA (EISA), peripheral component interconnect (PCI), peripheral component interconnect extended (PCIx), PCI express (PCIe), or any number of other technologies. The bus/IX may be a proprietary bus, for example, used in a SoC based system. Other bus/IX systems may be included, such as an I2C interface, an SPI interface, point to point interfaces, and a power bus, among others.

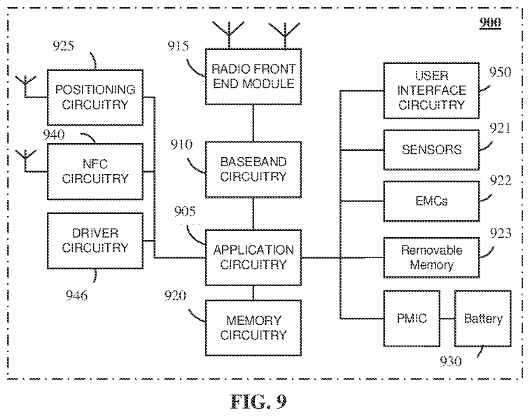

FIG. 9 illustrates an example of a platform 1000 (or “device 1000”) in accordance with various aspects. In aspects, the platform 1000 may be suitable for use as the UE 101, UE 101a, or UE 101b of FIG. 1, and/or any other element/component/device discussed herein such as the BS 111, BS 111a, or BS 111b of FIG. 1. The platform 1000 may include any combinations of the components or devices shown in the example. The components or devices of platform 1000 may be implemented as integrated circuits (ICs), portions thereof, discrete electronic devices, or other modules, logic, hardware, software, firmware, or a combination thereof adapted in the platform 1000, or as components or devices otherwise incorporated within a chassis of a larger system. The block diagram of FIG. 9 is intended to show a high level view of components or devices of the platform 1000. However, some of the components or devices shown may be omitted, additional components or devices may be present, and different arrangement of the components or devices shown may occur in other implementations.

Application circuitry 905 includes circuitry such as, but not limited to one or more processors (or processor cores), memory circuitry 920 (which includes a memory interface), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 905 may be coupled with or may include memory/storage elements/component/device and may be configured to execute instructions stored in the memory/storage to enable various applications or operating systems to run on the system 1000. In some implementations, the memory/storage elements/components/devices may be on-chip memory circuitry, which may include any suitable volatile and/or non-volatile memory, such as DRAM, SRAM, EPROM, EEPROM, Flash memory, solid-state memory, and/or any other type of memory device technology, such as those discussed herein.

The memory circuitry 920 can be used by the UE 101a to store instructions or configurations associated with the sensing service request 302, sensing message 306, the RRC sensing reconfiguration 330, performing sensing procedure 358, sensing data 338, or sensing response 348. The memory circuitry 920 can be used by the BS 111a to store instructions or configurations associated with the sensing service request 302, sensing message 306, the request for sensing 326, RRC sensing reconfiguration 330, the request for sensing acknowledgement 334, sensing data 338, sensing data 338, sensing response 348, or the sensing response 348.

As examples, the processor(s) of application circuitry 905 may include a general or special purpose processor, such as an A-series processor (e.g., the A13 Bionic), available from Apple® Inc., Cupertino, CA or any other such processor. The processors of the application circuitry 905 may also be one or more of Advanced Micro Devices (AMD) Ryzen® processor(s) or Accelerated Processing Units (APUs); Core processor(s) from Intel® Inc., Snapdragon™ processor(s) from Qualcomm® Technologies, Inc., Texas Instruments, Inc.® Open Multimedia Applications Platform (OMAP)™ processor(s); a MIPS-based design from MIPS Technologies, Inc. such as MIPS Warrior M-class, Warrior I-class, and Warrior P-class processors; an ARM-based design licensed from ARM Holdings, Ltd., such as the ARM Cortex-A, Cortex-R, and Cortex-M family of processors; or the like. In some implementations, the application circuitry 905 may be a part of a system on a chip (SoC) in which the application circuitry 905 and other components or devices are formed into a single integrated circuit, or a single package.

The baseband circuitry or processor 910 may be implemented, for example, as a solder-down substrate including one or more integrated circuits, a single packaged integrated circuit soldered to a main circuit board or a multi-chip module containing two or more integrated circuits. Furthermore, the baseband circuitry or processor 910 may cause transmission of various resources.

The platform 1000 may also include interface circuitry (not shown) that is used to connect external devices with the platform 1000. The interface circuitry may communicatively couple one interface to another. The external devices CONNECTED to the platform 1000 via the interface circuitry include sensor circuitry 921 and electro-mechanical components (EMCs) 922, as well as removable memory devices coupled to removable memory circuitry 923.

A battery 930 may power the platform 1000, although in some examples the platform 1000 may be mounted deployed in a fixed location, and may have a power supply coupled to an electrical grid. The battery 930 may be a lithium ion battery, a metal-air battery, such as a zinc-air battery, an aluminum-air battery, a lithium-air battery, and the like. In some implementations, such as in V2X applications, the battery 930 may be a typical lead-acid automotive battery.

While the methods are illustrated and described above as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or examples of the disclosure herein. Also, one or more of the acts depicted herein may be carried out in one or more separate acts and/or phases. In some examples, the methods illustrated above may be implemented in a computer readable medium or a non-transitory computer readable medium using instructions stored in a memory. Many other examples and variations are possible within the scope of the claimed disclosure.

As it is employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components or devices, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor can also be implemented as a combination of computing processing units. The processor or baseband processor can be configured to execute instructions described herein.

A UE or a BS, for example the UE 101 or BS 111 of FIG. 1 can comprise a memory interface and processing circuitry communicatively coupled to the memory interface configured to execute instructions described herein.

Examples (aspects) can include subject matter such as a method, means for performing acts or blocks of the method, at least one machine-readable medium including instructions that, when performed by a machine (e.g., a processor with memory, an application-specific integrated circuit (ASIC), a field programmable gate array (FPGA), or the like) cause the machine to perform acts of the method or of an apparatus or system for concurrent communication using multiple communication technologies according to aspects and examples described herein.

Example 1 is a sensing function (SF) entity, configured to: receive a sensing service request from an access and mobility function (AMF) entity, wherein the sensing service request is received by an access and mobility function/sensing function (AMF/SF) interface; transmit, by the AMF/SF interface, a sensing service response to the AMF entity; receive a sensing data associated with the sensing service response, wherein the sensing data is received by a base station/sensing function (BS/SF) interface; process the sensing data; and transmit a sensing response after processing the sensing data.

Example 2 includes Example 1, further configured to receive, by the AMF/SF interface, a sensing related information including one or more of, a sensing authentication information, a sensing policy information, a sensing requirement information, or a sensing application information, wherein the SF generates a sensing authentication command based on the sensing related information where the sensing service response includes the sensing authentication command, or the sensing data is processed based on the sensing related information.

Example 3 includes Example 1, wherein the SF entity is located within a base station.

Example 4 includes Example 1, wherein the sensing response includes one or more of a sensing processing report, or sensing commands.

Example 5 includes Example 1, wherein the sensing service request includes one or more of an extended protocol discriminator, security header type, serving temporary mobile subscription identifier (S-TMSI), message ID, or service type associated with local sensing operations.

Example 6 includes Example 1, wherein the BS/SF interface, provides an interface between the SF and a base station (BS), and the AMF/SF interface provides an interface between the SF and the AMF.

Example 7 includes Example 1, wherein the sensing data is received through a user plane or a control plane.

Example 8 includes Example 1, wherein the sensing response is transmitted by the BS/SF interface to a base station (BS) or by the AMF/SF interface to the AMF.

Example 9 is an access and mobility function (AMF) entity, configured to: receive a sensing message; select a sensing function (SF) entity based on the sensing message; transmit a sensing service request to the selected SF entity, wherein the sensing service request is transmitted by an access and mobility function/sensing function (AMF/SF) interface; receive, by the AMF/SF interface, a sensing service response associated with the sensing service request; and transmit a request for sensing based on the sensing service response.

Example 10 includes Example 9, further configured to: receive a sensing data; and transmit, by the AMF/SF interface, the sensing data.

Example 11 includes Example 9, wherein the sensing message includes at least one of a set of parameters or a sensing service request.

Example 12 includes Example 11, wherein the set of parameters include at least one of a serving temporary mobile subscription identifier (S-TMSI), a public land mobile network (PLMN) ID, location information, establishment cause, or user equipment (UE) context request.

Example 13 includes Example 11, wherein the sensing service request is associated with a user equipment (UE) that performs a sensing procedure in response to the AMF entity transmitting the sensing service request.

Example 14 includes Example 11, wherein the sensing service request is associated with a base station (BS) that performs a sensing procedure in response to the AMF entity transmitting the sensing service request.

Example 15 includes Example 9, further configured to receive a sensing related information including one or more of a sensing authentication information, a sensing policy information, and sensing requirement information.

Example 16 includes Example 15, wherein the SF entity is selected based on a sensing service type or sensing requirements, device capability, or device location as determined from the sensing message or the sensing related information.

Example 17 includes Example 15, further configured to transmit, by the AMF/SF interface, the sensing related information.

Example 18 includes Example 17, wherein one or more of selecting the SF entity, the sensing service request, or the sensing service response, are based on the sensing related information.

Example 19 includes Example 9, wherein the sensing service request includes one or more of an extended protocol discriminator, security header type, serving temporary mobile subscription identifier (S-TMSI), message ID, or service type associated with local sensing operations.

Example 20 includes Example 9, wherein the request for sensing includes one or more of a sensing configuration information, a security context, core network assistance information, user equipment (UE) capability parameters, and connection or mobility parameters.

Example 21 includes Example 20, wherein the sensing configuration information includes UE capability parameters which indicate a radio capability of a UE and an aggregated maximum bit rate (AMBR) for the UE.

Example 22 includes Example 20, wherein the sensing configuration information includes connection and mobility parameters which indicate a mobility restriction list, a list of recommended cells, timing advance (TA) values, and node identifiers.

Example 23 includes Example 9, further configured to receive an acknowledgement associated with the request for sensing.

Example 24 includes Example 9, further configured to: receive, by the AMF/SF interface, a sensing response; and transmit the sensing response.

Example 25 includes Example 24, wherein the sensing response includes one or more of a sensing processing report or sensing commands.

Example 26 is a baseband processor of a base station (BS), comprising: one or more processors configured to cause the BS to: transmit a sensing message based on a sensing service request, wherein the sensing service request is associated with a sensing procedure; receive a request for sensing in response to transmitting the sensing message; and transmit sensing data based on the sensing procedure associated with the sensing message, wherein the sensing data is transmitted by a base station/sensing function (BS/SF) interface.

Example 27 includes Example 26, wherein a sensing function (SF) is located within the BS.

Example 28 includes Example 27, wherein the one or more processors are further configured to: receive the sensing service request from a user equipment (UE), and wherein the sensing service request is generated by the UE.

Example 29 includes Example 26, wherein the one or more processors are further configured to: receive a paging request or a notification message comprising the sensing service request from a core network (CN) network function (NF), and wherein the sensing service request is generated by the CN NF.

Example 30 includes Example 26, wherein the sensing service request is generated by the BS.

Example 31 includes Example 26, wherein the sensing message includes a set of parameters and the sensing service request.

Example 32 includes Example 31, wherein the set of parameters comprises at least one of a serving temporary mobile subscription identifier (S-TMSI), a public land mobile network (PLMN) ID, location information, or establishment cause.

Example 33 includes Example 31, wherein the sensing message includes the sensing service request, and the sensing service request is generated by the BS.

Example 34 includes Example 31, wherein the one or more processors are further configured to: receive the sensing service request, wherein the sensing service request is generated by a user equipment (UE), and the sensing message includes the sensing service request.

Example 35 includes Example 34, the sensing message includes the set of parameters, and the set of parameters include a UE context request.

Example 36 includes Example 34, wherein the one or more processors are further configured to: transmit a request for sensing acknowledgment in response to receiving the request for sensing.

Example 37 includes Example 26, wherein the one or more processors are further configured to: perform a sensing procedure based on the request for sensing; and generate the sensing data based on the performed sensing operations.

Example 38 includes Example 26, wherein the one or more processors are further configured to: transmit a RRC sensing reconfiguration comprising the request for sensing to a user equipment (UE); and receive the sensing data based on the sensing procedure performed by the UE in response to receiving the RRC sensing reconfiguration.

Example 39 includes Example 26, wherein the request for sensing includes one or more of a sensing configuration information, a security context, core network assistance information, user equipment (UE) capability parameters, and connection or mobility parameters.

Example 40 includes Example 26, wherein the one or more processors are further configured to: receive a sensing response associated with the transmitted sensing data, wherein the sensing response includes one or more of a sensing processing report or sensing commands.

Example 41 includes Example 40, wherein the one or more processors are further configured to: transmit the sensing response to a user equipment (UE).

Example 42 is a baseband processor of a user equipment (UE), comprising: one or more processors configured to cause the UE to: transmit, a sensing service request, wherein the sensing service request is associated with a local sensing process; receive a RRC sensing reconfiguration comprising a request for sensing; perform a sensing procedure based on the request for sensing, where a sensing data is generated from the sensing procedure; and transmit the sensing data generated from the sensing procedure.

Example 43 includes Example 42, wherein the one or more processors are further configured to: receive a sensing response associated with the transmitted sensing data, wherein the sensing response includes one or more of a sensing processing report or sensing commands.

Example 44 includes Example 42, wherein the sensing service request includes one or more of an extended protocol discriminator, security header type, serving temporary mobile subscription identifier (S-TMSI), message ID, or service type associated with local sensing operations.

Example 45 includes Example 42, wherein the request for sensing includes one or more of a sensing configuration information, core network assistance information, user equipment (UE) capability parameters, and connection or mobility parameters.

Example 46 includes Example 42, wherein the sensing procedure includes performing measurements associated with a sensing objective to generate the sensing data.

Example 47 includes Example 42, wherein the sensing procedure includes establishing an interface with a dedicated sensor, instructing the dedicated sensor to perform measurements based on a sensing objective, and generating the sensing data based on the measurements performed by the dedicated sensor.

A method as substantially described herein with reference to each or any combination substantially described herein, comprised in examples 1-47, and in the Detailed Description.

A non-transitory computer readable medium as substantially described herein with reference to each or any combination substantially described herein, comprised in examples 1-47, and in the Detailed Description.

A wireless device configured to perform any action or combination of actions as substantially described herein, comprised in examples 1-47, and in the Detailed Description.

An integrated circuit configured to perform any action or combination of actions as substantially described herein, comprised in examples 1-47, and in the Detailed Description.

An apparatus configured to perform any action or combination of actions as substantially described herein, comprised in examples 1-47, and in the Detailed Description.

A baseband processor configured to perform any action or combination of actions as substantially described herein, comprised in examples 1-47, and in the Detailed Description.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communication media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal or apparatus.

In this regard, while the disclosed subject matter has been described in connection with various aspects and corresponding Figures, where applicable, it is to be understood that other similar aspects can be used or modifications and additions can be made to the described aspects for performing the same, similar, alternative, or substitute function of the disclosed subject matter without deviating therefrom. Therefore, the disclosed subject matter should not be limited to any single aspect described herein, but rather should be construed in breadth and scope in accordance with the appended claims below.

In particular regard to the various functions performed by the above described components or devices (assemblies, devices, circuits, systems, etc.), the terms (including a reference to a “means”) used to describe such components or devices are intended to correspond, unless otherwise indicated, to any component, device, or structure which performs the specified function of the described component or device (e.g., that is functionally equivalent), even though not structurally equivalent to the disclosed structure which performs the function in the herein illustrated exemplary implementations of the disclosure. In addition, while a particular feature can have been disclosed with respect to only one of several implementations, such feature can be combined with one or more other features of the other implementations as can be desired and advantageous for any given or particular application.

The present disclosure is described with reference to the attached drawing figures, wherein like reference numerals are used to refer to like elements, devices, or components throughout, and wherein the illustrated structures and devices are not necessarily drawn to scale. As utilized herein, terms “device,” “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable or non-transitory computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

As used herein, the term “circuitry” can refer to, be part of, or include an Application Specific Integrated Circuit (ASIC), an electronic circuit, a processor (shared, dedicated, or group), or associated memory (shared, dedicated, or group) operably coupled to the circuitry that execute one or more software or firmware programs, a combinational logic circuit, or other suitable hardware components that provide the described functionality. In some aspects, the circuitry can be implemented in, or functions associated with the circuitry can be implemented by, one or more software or firmware modules. In some aspects, circuitry can include logic, at least partially operable in hardware.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A base station (BS), comprising:
a radio frequency (RF) transceiver and one or more processors configured to,
when executing instructions stored in a memory, cause the BS to:
transmit a sensing message based on a sensing service request, wherein the sensing service request is associated with a sensing procedure;
receive a request for sensing in response to transmitting the sensing message; and
transmit sensing data based on the sensing procedure associated with the sensing message, wherein the sensing data is transmitted through a base station/sensing function (BS/SF) interface.

2. The BS of claim 1, wherein a sensing function (SF) is located within the BS.

3. The BS of claim 1, wherein the one or more processors are further configured to cause the BS to:
receive a paging request or a notification message comprising the sensing service request from a core network (CN) network function (NF), and wherein the sensing service request is generated by the CN NF.

4. The BS of claim 1, wherein the one or more processors are further configured to cause the BS to:
receive the sensing service request, wherein the sensing service request is generated by a user equipment (UE), and the sensing message includes the sensing service request.

5. The BS of claim 1, wherein the one or more processors are further configured to cause the BS to:
perform a sensing procedure based on the request for sensing; and
generate the sensing data based on the performed sensing procedure.

6. The BS of claim 1, wherein the one or more processors are further configured to cause the BS to:
transmit a radio resource control (RRC) sensing reconfiguration comprising the request for sensing to a user equipment (UE); and
receive the sensing data based on the sensing procedure performed by the UE in response to receiving the RRC sensing reconfiguration.

7. The BS of claim 1, wherein the one or more processors are further configured to cause the BS to:
receive a sensing response associated with the transmitted sensing data, wherein the sensing response includes one or more of a sensing processing report or sensing commands.

8. The BS of claim 7, wherein the one or more processors are further configured to cause the BS to:
transmit the sensing response to a user equipment (UE).

9. A sensing function (SF) entity, configured to:
receive a sensing service request from an access and mobility function (AMF) entity, wherein the sensing service request is received through an access and mobility function/sensing function (AMF/SF) interface;
transmit, through the AMF/SF interface, a sensing service response to the AMF entity;
receive sensing data associated with the sensing service response, wherein the sensing data is received through a base station/sensing function (BS/SF) interface;
process the sensing data; and
transmit a sensing response after processing the sensing data.

10. The SF entity of claim 9, further configured to receive, by the AMF/SF interface, a sensing related information including one or more of, a sensing authentication information, a sensing policy information, a sensing requirement information, or a sensing application information,
wherein the SF generates a sensing authentication command based on the sensing related information where the sensing service response includes the sensing authentication command, or the sensing data is processed based on the sensing related information.

11. The SF entity of claim 9, wherein the SF entity is located within a base station.

12. The SF entity of claim 9, wherein the sensing service request includes one or more of an extended protocol discriminator, security header type, serving temporary mobile subscription identifier (S-TMSI), message ID, or service type associated with local sensing operations.

13. The SF entity of claim 9, wherein the sensing data is received through a user plane or a control plane.

14. An access and mobility function (AMF) entity, configured to:
receive a sensing message;
select a sensing function (SF) entity based on the sensing message;
transmit a sensing service request to the selected SF entity, wherein the sensing service request is transmitted through an access and mobility function/sensing function (AMF/SF) interface;
receive, through the AMF/SF interface, a sensing service response associated with the sensing service request; and
transmit a request for sensing based on the sensing service response.

15. The AMF entity of claim 14, further configured to:
receive a sensing data; and
transmit, through the AMF/SF interface, the sensing data.

16. The AMF entity of claim 14, further configured to receive a sensing related information including one or more of a sensing authentication information, a sensing policy information, and sensing requirement information.

17. The AMF entity of claim 16, wherein the SF entity is selected based on a sensing service type or sensing requirements, device capability, or device location as determined from the sensing message or the sensing related information.

18. The AMF entity of claim 16, further configured to transmit, through the AMF/SF interface, the sensing related information.

19. The AMF entity of claim 14, wherein the request for sensing includes one or more of a sensing configuration information, a security context, core network assistance information, user equipment (UE) capability parameters, and connection or mobility parameters.

20. The AMF entity of claim 14, further configured to:
receive, through the AMF/SF interface, a sensing response; and
transmit the sensing response.
